(19) United States
(12) Patent Application Publication
(10) Pub. No.: US 2004/0136502 A1
(43) Pub. Date: Jul. 15, 2004

(54) Diagnostic quality control

(76) Inventors: Vivien Ann Munoz-Ferrada, New South Wales (AU); Carl Anthony Munoz-Ferrada, New South Wales (AU)

Correspondence Address: KNOBBE MARTENS OLSON & BEAR LLP, 2040 MAIN STREET, FOURTEENTH FLOOR, IRVINE, CA, 92614, US

(21) Appl. No.: 10/691,471

(22) Filed: Oct. 21, 2003

(30) Foreign Application Priority Data
Oct. 21, 2002 (AU) 2002952112
Feb. 28, 2003 (AU) 2003900923

(51) Int. Cl. H05G 1/00

(52) U.S. Cl. 378/210

(57) ABSTRACT

This invention concerns the testing of the operational performance of X-ray facilities. It involves an image scanner having at least 16 bit greyscale capability to scan a processed X-ray film bearing a test image having known image features at known locations, to create an electronic version of the image. And a programmed computer to measure the optical density of selected of the known features of the electronic image, to calculate predetermined performance indicators, and to deliver a report of operational performance. It related in particular, but not exclusively, the performance of X-ray film processors. The invention includes a number of different aspects, including a test method and test system for testing the operational performance an X-ray facility, in particular an X-ray film processor.

### TECHNICAL FIELD

This invention concerns the testing of the operational performance of X-ray facilities. In particular, but not exclusively, the performance of X-ray film processors. The invention includes a number of different aspects, including a test method and test system for testing the operational performance an X-ray facility, in particular an X-ray film processor.

### BACKGROUND ART

Each link in the radiographic imaging chain is important for final image quality, A near perfect latent image on film can be achieved through the use of proper X-ray equipment, techniques, positioning, and film/screen combinations. However, the final image is only as good as the film development process.

X-ray films are generally developed using an automatic film processor. The exposed X-ray film is unpacked in the darkroom and fed into the processor. The processed film is delivered outside the darkroom. A number of factors can affect the development process, such as temperature, replenishment rates, chemistry, water conditions, ventilation and the processor's working components. Recent government regulations require quality control testing of the processors.

Testing typically involves use of a sensitometer to expose a twenty-one step sensitometric strip (a series of numbered blocks having successively increasing exposure) onto a sample film in the darkroom. The film is then fed through the processor, the optical density of a sample of the twenty one steps on the processed film are accurately read using a densitometer, and the results recorded. The results can be used to identify variations in the performance of the processor from day to day, or relative to some standard.

### SUMMARY OF THE INVENTION

The invention is a test method for testing the operational performance an X-ray facility, in particular an X-ray film processor, comprising the steps of:

using an image scanner having at least 16 bit greyscale capability to scan a processed X-ray film bearing a test image having known image features at known locations, to create an electronic version of the image; and

using a programmed computer to measure the optical density of selected of the known features of the electronic image, to calculate predetermined performance indicators, and to deliver a report of operational performance.

A low cost commercially available flat bed scanner may be used. Suitable calibration may be necessary for the film. Modification may be useful to ensure the locations of the test image features are predictable in the scanned image. A simple template on the scanning bed may be sufficient modification for this purpose.

The test image may comprise a sensitometric strip, or alternatively a phantom image.

The programmed computer may be remote from the scanner and the electronic image may be sent to the computer over the Internet.

The performance indicators may include, but not be limited to, Speed Step (also known as “Mid Density”), Contrast Index (also known as “Density Difference), Base+Fog, Dmax and the Average Gradient.

The report of operational performance may include, but not be limited to, the data, and the layout, of the report templates of FIGS. 2 or 3. The report of operational performance may indicate whether the X-ray facility including the X-ray generator, the film processor, and the screen-film combination processor is operating within predetermined tolerances.

A charge may be raised on the basis of a fee for each report.

In a further aspect the invention is a test system for testing the operational performance an X-ray facility, in particular an X-ray film processor, comprising:

an image scanner having at least 16 bit greyscale capability to scan a processed X-ray film bearing a test image having known image features at known locations, to create an electronic version of the image; and

a programmed computer to measure the optical density of selected of the known features of the electronic image, to calculate predetermined performance indicators, and to deliver a report of operational performance.

In a further aspect the invention is a flat bed scanner having at least 16 bit greyscale capability and calibrated to scan a processed X-ray film bearing a test image having known image features at known locations, to create an electronic version of the image in which the locations of the test image features are predictable.

In a further aspect the invention is a programmed computer to measure the optical density of selected known features of an electronic version of a test image having known image features at known locations, to calculate predetermined performance indicators, and to deliver a report of operational performance.

In a further aspect the invention is a computer program to measure the optical density of selected known features of an electronic version of a test image having known image features at known locations, to calculate predetermined performance indicators, and to deliver a report of operational performance.

In a further aspect the invention is a signal transmitted from a scanner containing an electronic version of a test image having known image features at known locations, to a computer where the optical density of selected of the known features of the electronic image is measured, predetermined performance indicators are calculated, and a report of operational performance is prepared.

Advantages of good quality control include high quality images for diagnosis, and reduced need for repeat examination, protecting patients from unnecessary exposure to radiation.

On line Sensitometry is an accurate, economical and efficient method of carrying out film processor quality assurance utilising the latest internet technology and achieving a QA program that provides an immediate identification to any processing problems and consistent monitoring.

Online Sensitometry produces an accurate and consistent daily monitory QA system quickly and efficiently allowing radiographers to concentrate on patient care. It provides an immediate identification to any processing problems that may arise and notifies the radiographer on the corrective action required.

It has also proved to have added benefit in reducing capital expenditure on expensive densitometry equipment, ongoing maintenance and annual calibration costs.

Clinical trials were carried out two Interstate sites. One was a busy mammographic clinic and the other a general radiography clinic without emphasis on mammography work. The busy mammographic site was already carrying out manual QA however upon the introduction of the Online Sensitometry, it was found that their methodology for calculating the Speed and Contrast Index was incorrect, there was a marked variation in the base+fog values being measured, the developer temperature of the processor was operating above normal industry recommended limits for the type of film being utilised which resulted in a decrease in film contrast and a high base+fog value. This particular practice however was reluctant to introduce a change in their techniques as this would require a longer film dwell time and fewer patient throughput.

### BRIEF DESCRIPTION OF THE DRAWINGS

An example of the invention will now be described with reference to the accompanying drawings, in which:

FIG. 1 is block diagram of a film processor quality assurance system;

FIG. 2 is a diagnostic strip film analysis report; and

FIG. 3 is an alternative, weekly, diagnostic strip film analysis report.

### BEST MODES OF THE INVENTION

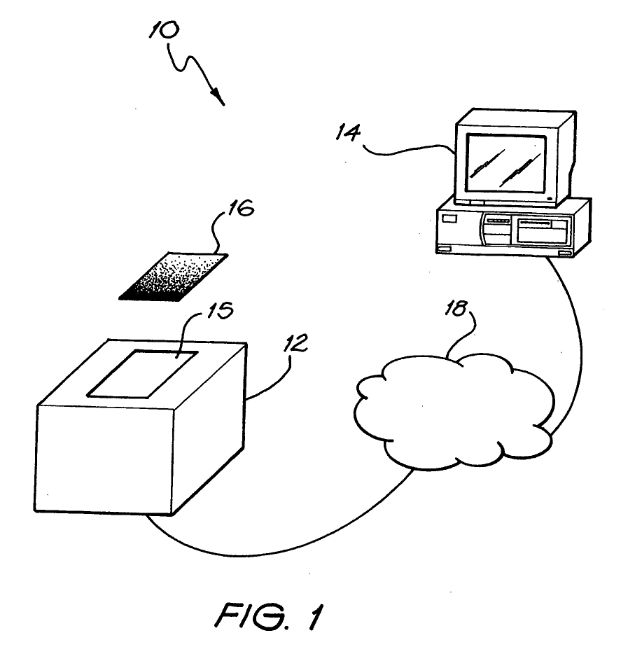

Referring first to FIG. 1 the system 10 involves a specially modified flat bed scanner 12 and a processing computer 14.

The scanner 12 is located at the radiographic practice, conveniently close to the processor 14 or processors to be monitored. The scanner 12 has sixteen bit greyscale capability and is calibrated to the film base used in the practice. The scanner 12 is also modified to have a template 15 on the scanning bed to receive the processed film 16 bearing a test image and to present the electronic version of the film and test image at a predetermined location. Furthermore, the scanner 12 is able to transmit the electronic version of the film over the Internet 18.

In this example, the film 16 is a sensitometric strip. The strip consists of a log graded series of twenty-one exposure steps with values that are already known. One end of the strip is left unexposed so that the gross density of the material itself can be determined.

The computer 14 is programmed with software to receive an electronic message containing the image scanned from the scanner 12, to measure and record the Optical Density of each step, calculate the Speed Step, Contrast Index, Base and Fog values, Dmax and the Average Gradient. During calibration the computer records identification and contact information, processor information such as make, model and serial number, and film information such as make, type, emulsion number and date.

In use, the sensitometric strip 16 which is either supplied pre-exposed or exposed by the customers sensitometer, is developed and placed on the scanner 12 within the template 15 provided. The strip 16 is then scanned and a check is made to ensure that all twenty one steps were captured by the scan. If the capture is not of a sufficient standard, the scan is repeated. Once the scan meets the standard, the image is saved and sent either directly to the computer 14 or to the computer 14, over the Internet 18. The ambient temperature at the processor 14 is also captured.

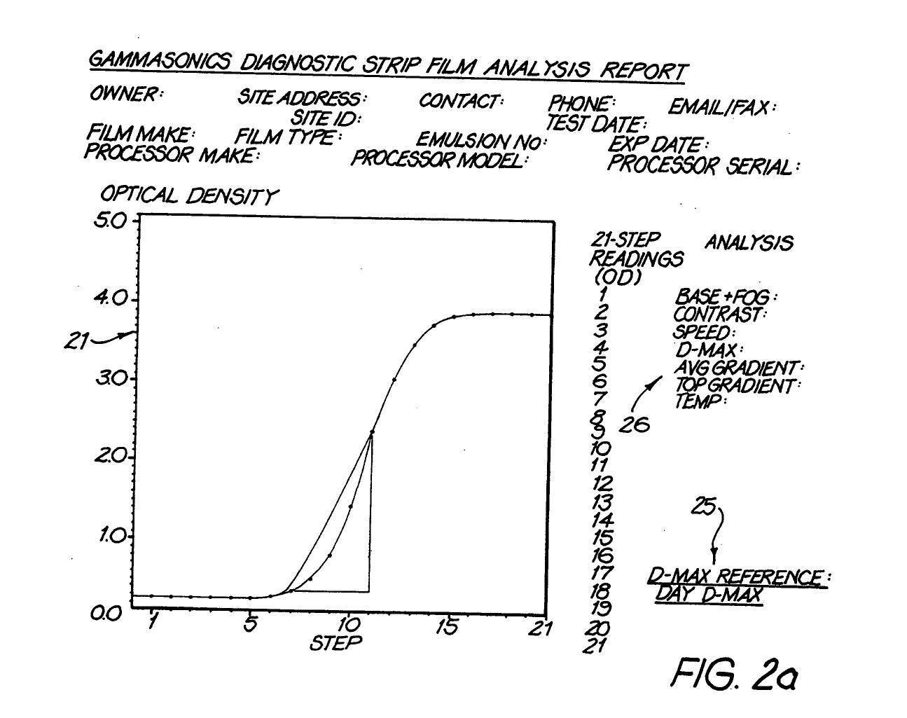

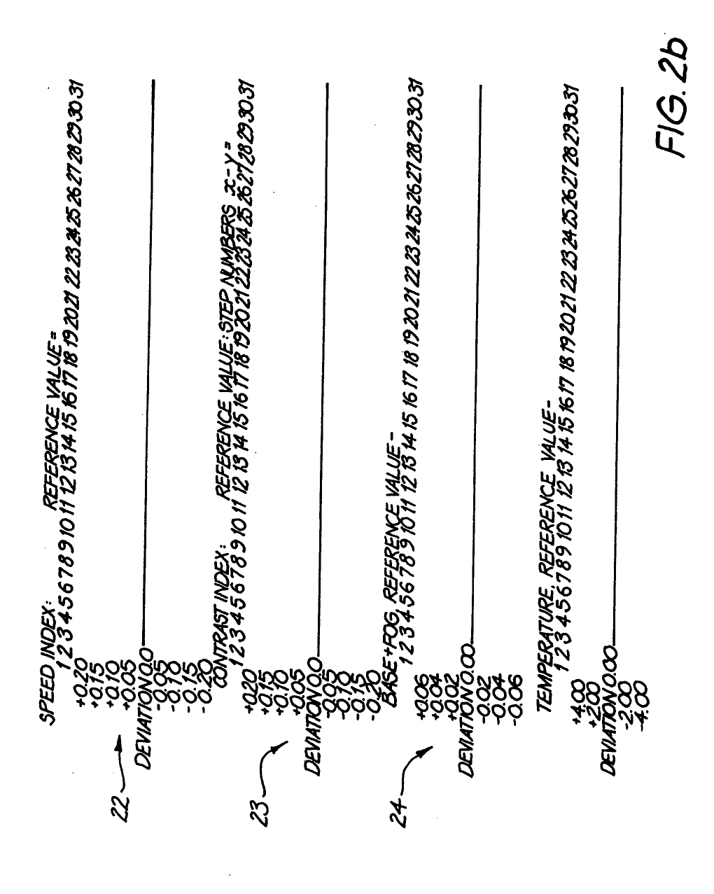

The computer 14 receives the image, measures and records the Optical Density of each step, and then plots the twenty-one steps, as illustrated in the report template of FIG. 2, to form a characteristic curve 21. The computer 14, then analyses the characteristic curve 21 to calculate and record the Speed Step 22, Contrast Index 23, Base and Fog values 24, Dmax 25 and the Gradient 26 of the straight-line section of the curve 21. This gradient 26 is interpreted as a measure of the contrast reproduced in the image, and therefore measures the degree of development of the processing materials, since changes in development affect contrast and hence the slope of the curve. The completed report template of FIG. 2 is then sent back to the radiographic practice as an email.

Since the densities of each characteristic curve are changed by changes in development, the gradient of the values of the straight line curve 26 and the contrast-index 23 are important tools used in processing control. Films developed to the same value, for example, show comparable tone reproduction. When both these parameters remain constant within predetermined tolerances, the processing is considered consistent.

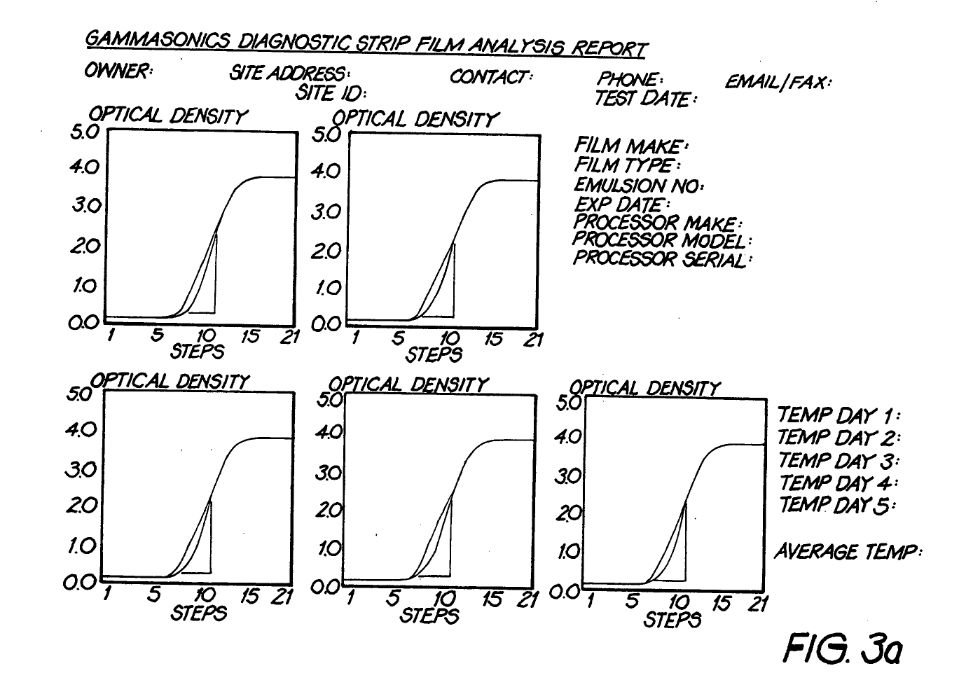

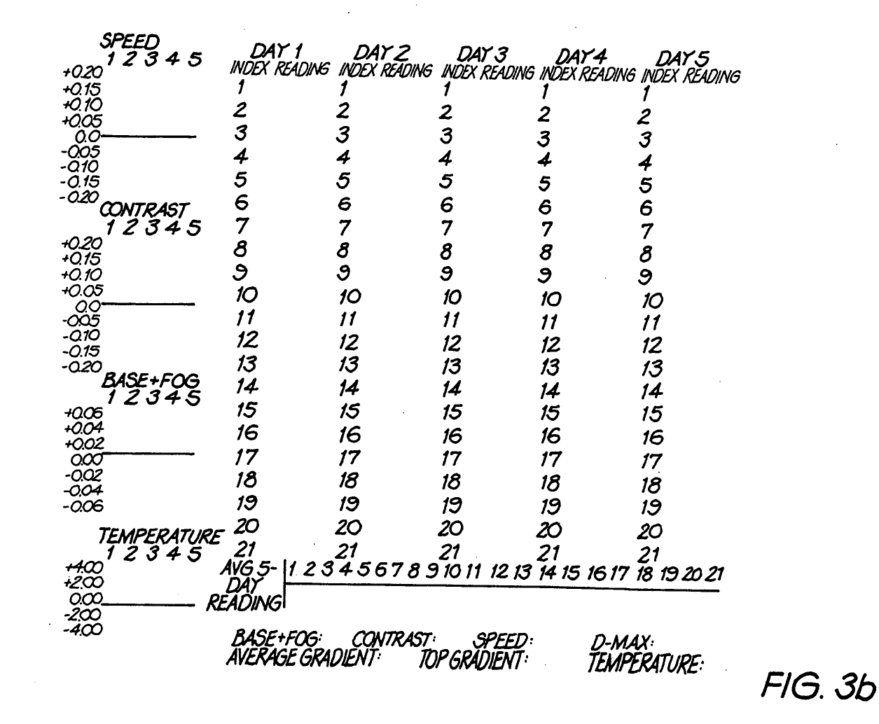

The report template of FIG. 3 is used to compare five days calibration reference data values, and comprises a full report that can be emailed back to the practice detailing any result outside the tolerances set. In the event that quality is substandard the report may also recommend what to look at to carry out corrective action, Based on the analysis of the report, an analyst and/or technician responsible for maintaining the test equipment may then make any necessary adjustments before processing any patient films.

Such a test may be carried out each morning before radiography is commenced.

Although the invention has been described with reference to a particular example, it should be appreciated that it encompasses additional possibilities. For instance, as well as testing sensitometric strips, the invention may also be applied to the task of testing images captured from phantoms. A phantom bears test images that mimic small structures such as fibrils, micro-calcifications and tumour like masses. For example, mammographic phantom images on a film act to simulate a breast containing various artefacts such as malignancies and small structures. These test images provide a uniform area for the measurement of the film's optical density and include areas of different attenuation that enable a contrast measurement, The size and contrast of the phantom images vary so as to be able to monitor the behaviour of a variety of performance variables in the X-ray facility, including the X-ray generator, the film processor, and the screen-film combination. Advantageously, the use of the phantom enables quick, easy and accurate evaluation of the overall imaging performance of an X-ray facility. As with the example above, the computer analyses the imaging changes which are then prepared in a report and sent back to the radiographic practice as an e-mail.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1. A test method for testing the operational performance an X-ray facility, comprising the steps of:
using an image scanner having at least 16 bit greyscale capability to scan a processed X-ray film bearing a test image having known image features at known locations, to create an electronic version of the image; and
using a programmed computer to measure the optical density of selected of the known features of the electronic image, to calculate predetermined performance indicators, and to deliver a report of operational performance.

2. A method according to claim 1, wherein the X-ray facility is an X-ray film processor.

3. A method according to claim 1, wherein the image scanner is a low cost commercially available flat bed scanner.

4. A method according to claim 1, wherein the film is calibrated.

5. A method according to claim 1, wherein the locations of the test image features are predictable in the scanned image.

6. A method according to claim 5, wherein a template on the scanning bed is used to ensure the locations of the test image features are predictable in the scanned image.

7. A method according to claim 1, wherein the test image comprises a sensitometric strip or a phantom image.

8. A method according to claim 1, wherein the programmed computer is remote from the scanner and the electronic image is sent to the computer over the Internet.

9. A method according to claim 8, wherein the performance indicators include Speed Step (also known as “Mid Density”), Contrast Index (also known as “Density Difference), Base+Fog, Dmax and the Average Gradient.

10. A method according to claim 9, wherein the report of operational performance includes the data, and the layout, of the report templates of FIGS. 2 or 3, and indicates. whether the X-ray facility including the X-ray generator, the film processor, and the screen-film combination processor is operating within predetermined tolerances.

11. A method according to claim 1, wherein a charge is raised on the basis of a fee for each report.

12. A test system for testing the operational performance an X-ray facility, comprising:
an image scanner having at least 16 bit greyscale capability to scan a processed X-ray film bearing a test image having known image features at known locations, to create an electronic version of the image; and
a programmed computer to measure the optical density of selected of the known features of the electronic image, to calculate predetermined performance indicators, and to deliver a report of operational performance.

13. A system according to claim 12, wherein the X-ray facility is an X-ray film processor.

14. A system according to claim 12, wherein the image scanner is a low cost commercially available flat bed scanner.

15. A system according to claim 12, wherein the film is calibrated.

16. A system according to claim 12, wherein the locations of the test image features are predictable in the scanned image.

17. A system according to claim 16, wherein a template on the scanning bed is used to ensure the locations of the test image features are predictable in the scanned image.

18. A system according to claim 12, wherein the test image comprises a sensitometric strip or a phantom image.

19. A system according to claim 12, wherein the programmed computer is remote from the scanner and the electronic image is sent to the computer over the Internet.

20. A system according to claim 19, wherein the performance indicators include Speed Step (also known as “Mid Density”), Contrast Index (also known as “Density Difference), Base+Fog, Dmax and the Average Gradient.

21. A system according to claim 20, wherein the report of operational performance includes the data, and the layout, of the report templates of FIGS. 2 or 3, and indicates. whether the X-ray facility including the X-ray generator, the film processor, and the screen-film combination processor is operating win predetermined tolerances.

22. A system according to claim 21, wherein a charge is raised on the basis of a fee for each report.

23. A flat bed scanner having at least 16 bit greyscale capability and calibrated to scan a processed X-ray film bearing a test image having known image features at known locations, to create an electronic version of the image in which the locations of the test image features are predictable.

24. A flat bed scanner according to claim 23, wherein the scanner is a low cost commercially available flat bed scanner.

25. A flat bed scanner according to claim 23, in combination a template on the scanning bed to ensure the locations of the test image features are predictable in the scanned image.

26. A flat bed scanner according to claim 23, wherein the test image comprises a sensitometric strip or a phantom image.

27. A programmed computer to measure the optical density of selected known features of an electronic version of a test image having known image features at known locations, to calculate predetermined performance indicators, and to deliver a report of operational performance.

28. A programmed computer according to claim 27, wherein the test image comprises a sensitometric strip or a phantom image.

29. A programmed computer according to claim 27, wherein the electronic version of the test image is produced by an X-ray film processor.

30. A programmed computer according to claim 29, wherein the programmed computer is remote from the X-ray film processor and the electronic image is sent to the computer over the Internet.

31. A programmed computer according to claim 27, wherein the performance indicators include Speed Step (also known as “Mid Density”), Contrast Index (also known as “Density Difference), Base+Fog, Dmax and the Average Gradient.

32. A programmed computer according to claim 31, wherein the report of operational performance includes the data, and the layout, of the report templates of FIGS. 2 or 3, and indicates. whether the X-ray facility including the X-ray generator, the film processor, and the screen-film a combination processor is operating within predetermined tolerances.

33. A programmed computer according to claim 32, wherein a charge is raised on the basis of a fee for each report.

34. A computer program to measure the optical density of selected known features of an electronic version of a test image having known image features at known locations, to calculate predetermined performance indicators, and to deliver a report of operational performance.

35. A computer program according to claim 34, wherein the test image comprises a sensitometric strip or a phantom image.

36. A computer program according to claim 34, wherein the electronic version of the test image is produced by an X-ray film processor.

37. A computer program according to claims 34, wherein the performance indicators include Speed Step (also known as “Mid Density”), Contrast Index (also known as “Density Difference), Base+Fog, Dmax and the Average Gradient.

38. A computer program according to claim 37, wherein the report of operational performance includes the data, and the layout, of the report templates of FIGS. 2 or 3, and indicates. whether the X-ray facility including the X-ray generator, the film processor, and the screen-film combination processor is operating within predetermined tolerances.

39. A computer program according to claim 38, wherein a charge is raised on the basis of a fee for each report.

40. A signal transmitted from a scanner containing an electronic version of a test image having known image features at known locations, to a computer where the optical density of selected of the known features of the electronic image is measured, predetermined performance indicators are calculated, and a report of operational performance is prepared.
